(19) United States
(12) Patent Application Publication
(10) Pub. No.: US 2002/0002550 A1
(43) Pub. Date: Jan. 3, 2002

(54) Process for enabling flexible and fast content-based retrieval

(76) Inventor: Andrew P. Berman, Tenafly, NJ (US)

Correspondence Address: Ronald M. Anderson, Esq., Law Offices Of Ronald M. Anderson, Suite 507, 600 - 108th Avenue N.E., Bellevue, WA, 98004, US

(21) Appl. No.: 09/779,019

(22) Filed: Feb. 7, 2001

Related U.S. Application Data
(60) Provisional application No. 60/181,607, filed on Feb. 10, 2000.

(51) Int. Cl. G06F 7/00

(52) U.S. Cl. 707/3; 707/104.1

(57) ABSTRACT

A method and system for retrieving database records, based on a close match to a specified query record, using a distance measure to determine the closeness of the match. The method employs a two-stage process to reduce the number of direct comparisons required. In a first stage, a triangle trie for a single distance measure is pruned to reduce a number of potential matches. The result obtained from pruning the triangle trie is further pruned by employing indexed tables generated using a triangle inequality technique. The members of this small set are then directly compared to the query record to identify matches within at least a specified degree of closeness. Multiple triangle tries can be combined to enable threshold searches over a composite measure. Operations, including Min, Max, Sum, and Weight are combined to produce more complex composite distance functions for use in the process.

### RELATED APPLICATION

This application is based on a prior co-pending provisional application, Ser. No. 60/181,607, filed on Feb. 10, 2000, the benefit of the filing date of which is hereby claimed under 35 U.S.C. §119(e).

### GOVERNMENT RIGHTS

This invention was partially funded by the National Science Foundation, under Grant No. IRI-971171. The United States Government may have certain rights in the invention.

### FIELD OF THE INVENTION

The present invention generally relates to searching a database for specific data, and more specifically, to a method and system for retrieving database records that are close matches to a specified query record, in a computationally efficient manner.

### BACKGROUND OF THE INVENTION

There is often a need for retrieving database records that are close matches to a specified query record. Wildcard searches in text-based databases are a well-known example of such a search for data matching at least a specified portion of a record. If the searcher is unsure of how to spell a word, or doesn't want to type in a whole word, a wildcard character such as an asterisk can be used in the query to indicate one or more characters of any kind. Thus, a searcher looking for textual documents referencing Albuquerque, New Mexico, who is unsure of how to spell Albuquerque, or who doesn't want to key in the entire word can enter a query using only “Alb*.” Although the results of such a search might include other data that also begins with “Alb” (for example, Alberta, Albany and Albania), references to Albuquerque will be included in the search results, if such references are within the data being searched.

Note that any textual item written in a language, by its very nature, is typically associated with a well-defined and bounded vocabulary. The vocabulary comprising a language readily permits searching for a specific word (or fragment or similar words). While textual databases can be extremely large, various algorithms are known that exploit a defined vocabulary associated with a textual language to enable a computer to efficiently index and retrieve any textual items stored in a database.

A common type of textual search algorithm indexes a textual item according to the presence of keywords included therein. Once a keyword is found, a pointer referring to that textual item is added to a list associated with that keyword. A data structure of pointers is generated, with each pointer defining a location in a textual database (which may be very large) at which the corresponding textual record for that keyword is stored. The keyword lists collectively define a keyword database. A user can then query the keyword database to retrieve the pointers for a keyword that correlate to the textual items in the textual database containing the keyword.

While such keyword algorithms for indexing a database and retrieving information work very well with textual data, other types of data are not so easily associated with a well-defined vocabulary. Thus, algorithms developed to facilitate searching of textual databases, or data similarly associated with a well-defined and bounded vocabulary, are of little utility with regard to data that are not associated with a well-defined and bounded vocabulary.

One frequently encountered data type that is not associated with a well-defined and bounded vocabulary is image data. With the explosive growth of digital imaging technology, large image databases are becoming increasingly commonplace, and methods for querying such databases are needed. Several searching methods have been developed, yet there exists room for improvement, particularly with respect to improving the efficiency of such searches, as well as enabling more flexible searches to be performed.

To search a collection of images, properties such as color, color layout, and textures occurring in the images can be queried. Such queries often employ a distance function measure. For example, given a database of images, a user may want to identify images in the database that are similar to a given image or “query image,” even if the query image is not precisely the same as any image in the database. In such cases, the search can employ distance measure scoring functions that rate the similarity of two records based on pre-defined criteria. A successful search will return database images, which have a minimum distance to the query image according to a specified distance measure.

To explain this technique more formally, a distance measure d is a function applied to two objects in a pre-defined domain U that returns a non-negative number relating the two objects, i.e., for any x, y εU, d(x, y)≧0. In the context of this discussion, U represents a record type used in a database. Objects x and y are records that match the record-type U in their construction, but are not necessarily in the database.

One distance measure technique developed to search image databases uses a query by image content (QBIC) paradigm. This technique was developed by IBM Corporation and is now being used for searching a database of paintings and other items in the State Hermitage Museum of St. Petersburg, Russia. Essentially, the QBIC technique classifies an image according to a number of pre-defined attributes, such as color distribution or layout, shapes within an image, texture, and edge locations of dominant objects in the image. For each image and each attribute of an image, a measurement is performed to generate a vector. A user queries a QBIC image database by providing an example or query image similar to that desired to be identified in the database or by entering parameters for one or more attributes for a search. Generally a user is enabled to suggest weighting differences for the attributes that should be present in an image identified by the search versus the query image. For example, if a user desires to find an image that has a color distribution very similar to the query image, but a different texture than the query image, a user can select a higher weight for the color distribution attribute and a lower weight for the texture attribute. The images in the database which most closely match the query image are displayed to the user. In the previous example, a database image that strongly matches the color and weakly matches the texture of the query image will be preferred over an image that strongly matches the texture and weakly matches the color of the query image.

Other known distance measuring techniques include eigen image paradigms, which are based on mathematical techniques for clustering vectors in space, and color distribution histograms. Each of these techniques involve attributes that can be quantified to enable distance measures to be made between a query image and the images contained in the database. While such systems produce usable results, they are computationally intensive. Even if a separate measure database is generated to hold a distance measure vector for each image in the image database, so that only distance measure vectors for the query image need to be generated at run time, comparing each distance measure vector for each image in an image database with a distance measure vector for the query image is computationally intensive. Furthermore, many of the systems developed to implement this technique do not offer much flexibility to a user with respect to defining a custom search. While a user can assign weights to each attribute, a user cannot construct a search based on complex combinations of the predetermined attributes (i.e., a user cannot define vectors based on the predetermined attributes). It would be desirable to enable more computationally efficient searches to be performed, and to allow greater flexibility in defining a search.

Another search paradigm is disclosed in U.S. Pat. No. 5,899,999 (De Bonet). This reference describes generating image signatures for use in searching rather than distance measurements. The image signature of an image is unique and is computed using multi-level iterative convolution filtering, with pixel values for each color axis supplied as input to each filtering level. A group of query images is provided, and a signature for each query image is identically generated. An averaging function is performed on the group of query image signatures, the average signature is compared to each image signature in the database, and all matches are displayed to a user. A user can select any of the matches and include the selected matches in the query image group, resulting in a new average query signature, which is once again compared to the image signatures in the database. The process can be repeated until a user is satisfied with the matches that are returned. However, the signature-generating process is computationally intensive. In a preferred embodiment, each image signature incorporates over 45,000 different image characteristics, and image signature generation requires over 1.1 billion computations (based on an image size of 256×256 pixels). Using a typical personal computer, each image signature will require approximately 1½ minutes to generate. Preferably, image signatures are computed for each image as it is added to a database, creating a separate database for image signatures to reduce the time required to later perform a search. While this method provides good resolution, it is also too computationally intensive when conducting a search. Generating image signatures for each member of the query group is computationally intensive and time consuming, but then, each image signature relating to an image within the image database must be compared with the average of the query image signatures, which is also a computationally intensive step.

While the various image retrieval paradigms discussed above are functional, they are characteristically computationally intensive. There are methods known in the prior art to reduce the number of direct comparisons required in a threshold-style database search, thereby reducing the computational effort required. A common search technique in database technology uses an index, which is a data structure that enables desired information to be retrieved from a database without the need to visit every record in the database. Many commercial database systems, such as the database program sold by Oracle Corporation, use indexing techniques to efficiently retrieve information from a database. Many different indexing algorithms and techniques exist, and the increase in efficiency they provide is dependent upon the specific algorithm employed and the nature of the data being searched.

While most indexing schemes are not particularly applicable to searching image databases, U.S. Pat. No. 6,084,595 (Bach) describes a search engine that uses indexed retrieval to improve computational efficiency in searching large databases of rich objects such as images. Feature vectors are extracted from each image, based on specific image characteristics such as color, shape, and texture, and are then stored in a feature vector database. When a query is submitted to the engine, a query feature vector Q is specified, as well as a distance threshold T, indicating the maximum distance that is of interest for the query. Only images within the distance T will be identified by the query. By reducing the number of feature vectors retrieved from the database and the number of feature vector comparisons, the query process becomes much more efficient. This patent discloses that several different indexing algorithms can be employed, including B-tries, R-tries, and X-tries. It should be noted that other indexing algorithms are possible, and that other types of vectors can be indexed.

A different known method for reducing the number of direct comparisons in a threshold-style database search takes advantage of a concept known as “triangle inequality.” Such a system is described in “A Flexible Image Database System for Content-Based Retrieval,” by Andrew P. Berman and Linda G. Shapiro, 17^{th} International Conference on Pattern Recognition (1998). The triangle inequality is based on the fact that the distance between two objects cannot be less than the difference in their distances to any other object. Thus, by comparing the relative distances between a query object and a database object to one or more key objects, a lower bound on the distance from the query to the database object can be determined. It should be understood that the Flexible Image Database System (FIDS) employs an entirely different vector than the feature vector described in U.S. Pat. No. 6,084,595. Instead of feature vectors, FIDS employs relational vectors, which are then indexed. A relational vector does not include information about the fixed properties of an image, but instead contains data relating the differences in properties between the image and some other image. Assuming that color is a metric of interest, a fixed vector might indicate that a particular image is 30% red. In contrast, a relational vector based on a color metric might indicate that a particular image shares 50% of the colors of an image selected as a reference key. If a different reference key is selected, the relational vector can change.

The FIDS disclosure also indicates that most query systems are relatively inflexible. While text-based retrieval techniques enable a user great flexibility in constructing customized and user-defined searches, image searching systems often don't provide similar flexibility with respect to searching data that are not so associated with a well-defined and bounded vocabulary. The FIDS disclosure teaches that flexibility is an important quality in any generalized content-based retrieval system. For example, a user should be able to formulate a query such as “Match on colors, unless the texture and shape are both very close;” or “two out of three of color, texture, and shape must match.” Such queries cannot be expressed as a weighted sum of individual distance measures.

FIDS enables complex combinations of distance measures when searching and further provides a distance measure-based retrieval method that enables a user to define distance measure parameters when searching, thereby enabling a user's definition of similarity to change from session to session, rather than simply providing a system that employs a fixed distance measure. FIDS also provides a system that includes a pre-defined set of base-distance measures that users can combine in multiple ways to create more complex distance measures.

FIDS incorporates the following set of operations to enable more expressive queries (where d₁ . . . dₙ represent distance measures):

Addition: d=d₁+d₂

Weighting: d=cd₁, where c is a weighting factor

Max: d=Max(d₁, d₂, . . . , dₙ)

Min: d=Min(d₁, d₂, . . . , dₙ)

To generate FIDS relational vectors for all of the images in a database, several images from the database are selected at random and defined as keys. Relational vectors are then generated for each image in the database that describe each image not as a function of fixed metrics, but rather describe each image in relation to a selected key.

With respect to the triangle inequality, let I represent a database object, Q represent a query object, K represent an arbitrary fixed object known as a key, and d represent some distance measure that is a metric. As d is a pseudo-metric, the following two triangle inequalities must be true:

d(I, Q)+d(Q, K)≧d(I, K) (1)

d(I, Q)+d(I, K)≧d(Q, K) (2)

These two triangle inequalities can be combined to form the following inequality, which places a lower bound on d(I, Q):

d(I, Q)≧|d(I, K)−d(Q, K)| (3)

Thus, by comparing the database and query objects to a third key object, a lower bound on the distance between the two objects can be obtained. Next, define l(d, K, I, Q)=|d(I, K)−d(Q, K)| to be equal to this lower bound on d(I, Q), and further, it is possible to shorten the expression l(d, K, I, Q) to l(d, K), when there is no confusion as to the identity of I and Q.

Equation (3) can be extended by substituting a set of keys K=(K₁, . . . , K_{M}) for K as follows:

d(I, Q)≧max₁≦s≦_{M}|d(I, Kₛ)−d(Q, Kₛ)| (4)

It will be apparent that the inequality indicated above is valid by noting that Equation (3) is valid for all values of s. Next, define l′(d, K, I, Q) to be equal to the lower bound on d(I, Q) found by using Equation (4). As before, the expression l′(d, K, I; Q) can be shortened to l′(d, K) where possible.

Consider a large set of database objects, S={I₁, . . . , Iₙ} and a much smaller set of key objects, K={K₁, . . . , Kₘ}. Then, pre-calculate d(Iₛ, Kₜ) for all {1≦s≦m}×{1≦t≦n}. Now consider arequest to find all database objects Iₛ, such that d(I_{I}ₛ, Q)≦t for some query image Q and threshold value t. Lower bounds on {d(I₁, Q), . . . , d(Iₙ; Q)} can be determined by calculating {d(Q, K₁), . . . , d(Q, Kₘ)} and repeatedly applying Equation (4). If it is proven that t is less than d(Iₛ, Q), then Iₛ can be eliminated from the list of possible matches to Q. After the elimination phase, a linear search can be performed through the non-eliminated objects, comparing each to Q in the standard fashion. This process involves m+u distance measure calculations, and O(mn) simple (constant cost) operations, where u is the number of non-eliminated objects. The hope is that m+u is sufficiently smaller than n to result in an overall time savings.

Using the triangle inequality, an index can be generated such that the index can be quickly and efficiently searched, to determine the database objects that should be retrieved for comparison with a query object. Assume that the sample database is an image database comprising the images S=(I₁, . . . , I₆). The keys are images K=(K₁, K₂). To initialize the database for distance measure d, calculate d(Iₛ, Kⱼ) for all s, j, as shown below in Table 1.

A search goal might be to find all images Iₛ in the database, such that d(Iₛ, Q)≦2 for some query object Q. It is possible to calculate d(K₁, Q)=3 and d(K₂, Q)=5. Subtract 3 from each element in the first column in Table 1 and subtract 5 from each element of the second column. Then, place the absolute values of the results in Table 2, as shown below. Minimum distances of each image in a database to query image q are then calculated by use of the triangle inequality, where d(K₁, q)=3 and d(K₂, q)=5. Note that in Table 2, l′(d, K) is obtained by taking the maximum value of l′(d, K₁) and l′(d, K₂), as defined in Equation (4).

TABLE 1
Sample Database and Stored Distances

| Image | d(I, K₁) | d(I, K₂) |
|---|---|---|
| I₁ | 2 | 8 |
| I₂ | 4 | 4 |
| I₃ | 1 | 5 |
| I₄ | 6 | 9 |
| I₅ | 4 | 1 |
| I₆ | 7 | 3 |

TABLE 2

| Image | l(d, K₁) | | l(d,K₂) | | l′(d,K) |
|---|---|---|---|---|---|
| I₁ | 2-3 | =1 | 8-5 | =3 | 3 |
| I₂ | 4-3 | =1 | 4-5 | =1 | 1 |
| I₃ | 1-3 | =2 | 5-5 | =0 | 2 |
| I₄ | 6-3 | =3 | 9-5 | =4 | 4 |
| I₅ | 4-3 | =1 | 1-5 | =4 | 4 |
| I₆ | 7-3 | =4 | 3-5 | =2 | 4 |

By examining the values of l′(d, K, Iₛ, Q) for 1≦s≦6, it will be apparent that only I₂ and I₃ can possibly be within a distance of 2 to query Q. Thus, only d(I₂, Q) and d(I₃, Q) need to be calculated to determine all close matches to Q. The efficiency of the process is highly dependent on the selection of keys, the relative expense of distance measure calculation, and the statistical behavior of the distance measure over the set of database objects. This process can be further modified to return all or a subset of the database objects ordered by their calculated lower bounds, least to greatest. There is strong experimental evidence that such an ordering will place the best matches very close to the front of the list.

It is possible to extend the above scheme to work with combinations of distance measures. The intuition is that lower bounds on the distance between two objects for distance measures d₁ and d₂ can often be used to calculate a lower bound between the objects for distance measure d, when d can be calculated as a combination of d₁ and d₂.

For example, let D={d₁, . . . , dₚ} be a set of distance measures. These distance measures will be known as the base distance measures. Let K′={K₁, . . . , Kₚ} be a sequence of sets of keys, one set of keys being provided for each distance measure. Note that each set may have a different number of keys and that the sets may or may not intersect. Let l(D, K′, I, Q) be the set of lower bounds l′(dₛ, Kₛ, I, Q) calculated from Equation (4) for each pair (dₛεD, KₛεK′), and 1≦s≦p.

Now consider a new distance measure d′ that is of the form:

d′(I, Q)=f(d₁(I, Q), . . . , dₚ(I, Q)) (5)

where f is monotonically non-decreasing in its parameters. For example, f might describe a weighted sum of the base measures, or even combinations of minimums and maximums of sets of the base measures. Since l′(dₛ, Kₛ, I, Q)≦dₛ(I, Q) for all s, substituting l′(dₛ, Kₛ, I, Q) for each instance of dₛ(I, Q) gives:

d′(I, Q)≧f(l′(d₁, K₁, I, Q), . . . , l′(dₚ, Kₚ, I, Q). (6)

Thus, it is possible to calculate a lower bound on d′(I, Q), given lower bounds on the base distance measures. The database images can either be ordered based on these lower bounds or the threshold can be applied to identify database images as candidates for matches to the query image. It should be noted that the operations on distance measures described above (Addition, Weighting, Max, and Min) can be combined to form monotonically non-decreasing functions.

As described above in relation to single distance measures, indexing can be used to reduce computational requirements. Indexing can also be applied to multiple distance measures. Assume a database comprises a set of images (I₁, . . . , I₆), with two base distance measures (d₁, d₂) and two sets of keys, K₁=(K₁₁, K₁₂) and K₂=(K₂₁, K₂₂). Pre-calculate dₛ(Iₜ, Kₛᵤ) over all s, t, u to obtain Table 3, which is shown below. Now assume a query Q and distance measure d′(X, Y)=d₁(X, Y)+3d₂(X, Y) and find all objects I in the database such that d′(I, Q)≦10. To do so, calculate d₁(K₁₁, Q)=3, d₁(K₁₂, Q)=5, d₂(K₂₁, Q)=2, and d₂(K₂₂, Q)=8. Taking the absolute differences between these values and the values in Table 3 provides the l(dₛ, Kₛᵤ) values over s, u, which are combined to calculate l(d₁, K₁) and l(d₂, K₂). These results are combined to produce the l′(d′, K′) values (note that the l′(d′, K′) values are obtained using the d′(X,Y)=d₁(X, Y)+3d₂(X, Y) relationship defined above). The l(dₛ, Kₛᵤ) and l′(d′, K′) values are shown below in Table 4. In this case, l′(d′, I₅, Q, K′)≦10 and l′(d′, I₂, Q K′)≦10. Thus, I₂ and I₅ are returned as possible matches, with the images eliminated.

As described above, it is possible to modify the process to return the best match. In this case, the images are returned in increasing order of their l′(d′, K) (I₅, I₂, I₁, I₄, I₃, I₆). Direct comparisons can then be made from the query image some prefix of this set to validate the best image.

TABLE 3
Sample Database & Stored Distances with Multiple Distance
Measures

| Image | d₁(K₁₁, I) | d₁(K₁₂, I) | d₂(K₃₂, I) | D₂(K₂₂, I) |
|---|---|---|---|---|
| I₁ | 2 | 8 | 5 | 15 |
| I₂ | 4 | 4 | 3 | 6 |
| I₃ | 1 | 5 | 12 | 9 |
| I₄ | 6 | 9 | 10 | 8 |
| I₅ | 4 | 1 | 2 | 8 |
| I₆ | 7 | 3 | 15 | 15 |

TABLE 4
Calculating Lower Bounds on d′ = d₁ + 3d₂ by Use of Triangle
Inequality

| Image | l(d₁, K₁₁) | l(d₁, K₁₂) | l(d₂, K₂₁) | l(d₂, K₂₂) | l′(d′, K′) |
|---|---|---|---|---|---|
| I₁ | 1 | 3 | 3 | 7 | 3 + 3 * 7 + 24 |
| I₂ | 1 | 1 | 1 | 2 | 1 + 3 * 2 = 6 |
| I₃ | 2 | 0 | 10 | 1 | 2 + 3 * 10 = 32 |
| I₄ | 3 | 4 | 8 | 0 | 4 + 3 * 8 = 28 |
| I₅ | 1 | 4 | 0 | 0 | 4 + 3 * 0 = 4 |
| I₆ | 4 | 2 | 13 | 7 | 4 + 3 * 13 = 43 |

Although much faster than making direct comparisons of parameters of a query image to each image of a database, the basic triangle inequality process described above has a running time of the number of images and the number of keys. Running time may become unacceptable for very large databases with a large number of keys. It would be desirable to further improve the computational efficiency provided by triangle inequality-based indexing functions.

A very computationally efficient data structure for approximate match searching is a triangle trie, otherwise known as a Really Fixed Query Trie. A triangle trie is associated with a single distance measure, a set of key images, and a set of database elements. It is a form of trie, which is a trie in which the edges leading from the root to a leaf “spell out” the index of the leaf. The leaves of the trie contain the database elements. Each internal edge in the trie is associated with a non-negative number and each level of the trie is associated with a single key. The path from the root of the trie to a database element in a leaf represents the distances from that database element to each of the keys.

FIG. 1 illustrates a triangle trie 10 with four elements (W, X, Y, Z), and two keys (A, B). The distance relationships between the elements and the keys can be described as vectors. The distance from W to A is 3, and the distance from W to B is 1, thus a first vector describing W is (3, 1). The distance from X to A is 3, and the distance from X to B is 1, thus a second vector describing X is also (3,1). Given a distance from Y to A of 3, and a distance from Y to B of 9, a third vector describing Y is (3, 9). Finally, the distance from Z to A is 4, and the distance from Z to B is 8, thus a fourth vector describing Z is (4, 8).

The vector describing the distance relationship between W and the keys A and B is expressed in trie 10 by the path from a root 12 to element W. This path passes through a node 14a in a level 18a (note level 18a is associated with key_{A}) and a leaf 16a in a level 18b (note level 18b is associated with key_{B}). The vectors for elements X, Y, and Z are similarly expressed. Each element is in precisely one leaf, yet each leaf can contain more than one element. While not required, each level is indicated by a dash line box, each node is indicated by a square, and each leaf is indicated by a circle.

Constructing a trie is a straightforward process, as is illustrated in FIGS. 2A-2E. First the distances from the keys to the database elements are computed. Next, an empty trie is created in FIG. 2A by positioning root 12. Next, the database elements are inserted one at a time, using the vector for each element's key distances. Element W is incorporated into a trie in FIG. 2B, resulting in node 14a and leaf 16a being generated. In FIG. 2C, element X, which is defined by the same relational vector as element W, is incorporated into the trie. Because the vectors are identical, no nodes or leaves are added, and element X is added to the description associated with leaf 16a. Element Y is incorporated into the trie in FIG. 2D. Since element Y is described by a relational vector that has one element in common with the relational vectors for W and X, a new leaf 16b is added. In FIG. 2E element Z is incorporated into the trie, and as the relational vector describing Z has no commonality with the other relational vectors, a new node 14b and a new leaf 16c must be added.

Formally, when constructing a trie, let S=(x₁, . . . , xₙ) be the set of objects in the database. Let key₁, . . . , keyⱼ be another set of objects, known as “key objects.” For each x₁ in S, compute the vector v₁=(d(xᵢ, key₁), d(xᵢ, key₂), . . . , d(xᵢ, keyⱼ)). Then combine the vectors v₁, . . . , vₙ into a trie, with xᵢ being placed on the leaf reached by following the path represented by vᵢ. With respect to FIGS. 1 and 2A-E, S=(W, X, Y, Z) are the elements (images or other data objects), and A and B define the set of keys. As noted above, the relational vectors are defined by v_{W}=(3, 1), v_{X}=(3, 1), v_{Y}=(3, 9), and v_{Z}=(4, 8).

If each element in each leaf of a trie is examined in a query, no computational savings are realized. The computational savings are realized only when elements in leaves of a trie are “pruned.” A pruned element is automatically discarded from the query. Ideally, pruning eliminates a significant number of elements, so that a minimal number of elements are actually examined for direct comparison with the query object.

Suppose a query q and threshold integer T are given, and it is desired to find all objects in the database with a distance from q of not more than T. Now, consider a node p at level l with a value of C. Every object at leaves that are descendant from p is a distance C from the key object keyₗ. Thus, if |C−d(q, key₁)| is greater than T, then it is known from the triangle inequality that d(q, s′) is greater than T for all objects s′, which are descendants of p. Accordingly, it is possible to safely prune the search at node p.

The process for pruning a triangle trie is straightforward. Compute the distances from q to each key: d(q, key₁), . . . , keyⱼ). Perform a depth-first search of the trie. If there is a node p at level 1 with a value C such that |C−d(q, key₁)|>T, then prune the search at node p. When a leaf is reached, measure the distance from q to every object in the leaf and return those objects i for which d(q, i) is less than or equal to T.

Consider trie 10 of FIG. 1. To search the database for a close match to object V where the maximum allowed distance to V is 1, first compute vᵥ by calculating d(V, key₁) and d(V, key₂). From the result, it appears that vᵥ=(3, 8). Now perform a depth-first search. At the top level, only search nodes with a value within 3±1 (1 being the maximum allowed distance to V). At the second level, only search children of those nodes with a value within 8±1. FIG. 3 shows the trie with nodes 14a and 14b, and leaves 16b and 16c that were examined as shaded, indicating that Y and Z are returned as potential matches, while X and W are eliminated. The final step is to compute d(V, Y) and d(V, Z). The process does not need to compute d(V, X) and d(V, W).

Triangle tries can theoretically be used for retrieving approximate matches for single distance measures in a sub-linear number of operations relative to the size of the database being searched, and the number of key objects selected. Note that each key object adds a new level to the trie. Also, as the number of data objects increases, and the number of key objects increase, the breadth of a triangle trie also expands, up to a maximum breadth equal to the number of database elements. Thus, a triangle trie fully defining a distance measure in a large database will likely be quite large.

Note that the value of a pruning step is directly related to the number of leaves of the pruned sub-trie. Thus, as the breadth increases, the performance of the trie-pruning process decreases until it is unfavorable when compared to directly calculating lower bounds for each database object by comparing relational vectors of each data object with the query object. On the other hand, the total pruning ability of the triangle trie increases with the number of keys used. This increase leaves the potential user of a triangle trie with the choice of either reducing the pruning ability or increasing the time taken to traverse the trie. Because for databases of moderate and large size, using a fully developed triangle trie that includes a level for each key is likely to offer little efficiency gain, it would be desirable to provide a method of using partially developed triangle tries that enables a useful level of pruning to be quickly obtained.

Note that a single triangle trie relates to only a single metric, or distance, measure. A distance measure refers to some quantifiable characteristic of the data. For example, if the data comprise images, distance measures can include color, texture, shape, etc. Each distance measure will require a separate set of relational vectors, and a separate triangle trie. If five different distance measures are defined, then five different sets of relational vectors will be formed, and five different triangle tries will be required. While multiple triangle tries could be used to perform multiple distance measurements, and the results of each triangle trie could then be summed to define the set of objects to be retrieved from the database for comparison to a query object; for a large database with many key objects, generating a large number of triangle tries is computationally intensive. Furthermore, the larger the database, the larger the triangle trie, and the smaller the increase in efficiency. It would therefore be desirable to develop a method of employing multiple triangle tries for multiple distance measures in a relatively large database with greater efficiency.

While several methods are known for reducing the number of direct comparisons in a threshold-style database, because databases can be so large, it would be desirable to employ a method and system that are even more efficient to enable a user to define multiple distance measures when searched, rather than merely selecting an option from a pre-defined menu. Such an approach should preferably employ relational vectors so that triangle equality-based bound limiting algorithms and indexes can be employed. Also, the technique should efficiently employ triangle tries in relatively large database environments. The prior art does not teach or suggest such method or system.

### SUMMARY OF THE INVENTION

The present invention defines a method for reducing the number of direct comparisons required to identify any data objects in a set of data objects that match a query data object. The method includes the steps of determining a set of key objects in the set of data objects and a set of relational vectors, such that for each data object, a relational vector describes at least one type of distance measure between that data object and each key object. A triangle trie is determined for each different type of distance measure used in generating the relational vectors, such that each triangle trie has a number of levels that is less than the number of key objects.

A user is enabled to select a query object and at least one type of distance measure that will be used to match a data object to the query object. For each distance measure selected, a query relational vector is determined that describes a distance measure between the query object and each key object. Each triangle trie related to a distance measure selected by a user is pruned to eliminate any data objects from the set of data objects that cannot match the query object within at least a degree of closeness determined by the user, thereby reducing a number of data objects that potentially will require direct comparisons with the query object. The remaining data objects are then directly compared to the query object to identify any data objects that match the query object to within at least the specified degree of closeness.

Preferably, more than three key objects are provided, such that each triangle trie includes at least three levels. Also, a user is preferably enabled to formulate a query based on a complex combination of distance measures.

In at least one embodiment, a complex query can include at least one of a summation function, a minimum function, a maximum function, and a weight function. When a summation function is selected to be applied to at least two different distance measures, the results from each triangle trie corresponding to the at least two different distance measures to which the summation function is applied are summed together, reducing a number of data objects that potentially will require direct comparisons with the query object.

If a user formulates a query that includes a maximum function applied to at least two different distance measures, the results from each triangle trie corresponding to the at least two different distance measures to which the maximum function is applied are merged together by taking their intersection, thereby reducing the number of data objects that potentially will require direct comparisons with the query object.

With respect to a query that includes a minimum function applied to at least two different distance measures, the results from each triangle trie corresponding to the at least two different distance measures to which the minimum function is applied are merged together by taking their union, similarly reducing the number of data objects that potentially will require direct comparisons with the query object.

When a query includes a weight function applied to at least one distance measure, the weight function changes the degree of closeness proportional to the weight assigned. If the degree of closeness specified by a user is a distance X, and the weight assigned to a particular distance measure is 80%, then the results from the triangle trie corresponding to the 80% weighted distance measure are compared to 80% of X.

In one embodiment, the results of pruning any triangle trie are further pruned by comparing relational vectors corresponding to data objects from the set of data objects that have not yet been eliminated with the query relational vector, further reducing the number of data objects that will require direct comparisons with the query object. Preferably, the second-stage pruning step employs pre-generated index tables based on a triangle inequality.

Another aspect of the present invention is directed to an article of manufacture adapted for use with a computer. The article includes a memory medium and a plurality of machine instructions stored on the memory medium, which when executed by a computer, cause the computer to carry out functions generally consistent with steps of the method described above.

Yet another aspect of the present invention is directed to a system that includes a memory in which a plurality of machine instructions are stored, a display, an input device, and a processor that is coupled to the display and to the memory to access the machine instructions. The processor executes the machine instructions, thereby implementing a plurality of functions that are generally consistent with the steps of the method described above.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a graphic illustration showing two levels of an exemplary triangle trie;

FIGS. 2A-2E illustrate logical steps for generating the triangle trie in FIG. 1;

FIG. 3 illustrates steps employed in pruning the triangle trie in FIG. 1;

FIG. 4 is a flowchart illustrating the overall logical steps implemented to carry out the present invention;

FIG. 5 shows the steps performed when pruning the triangle trie of FIG. 1, based on a different query object than that illustrated in FIG. 3;

FIGS. 6A and 6B illustrate partial triangle tries constructed to facilitate a query including two different distance measures;

FIG. 7 is a flowchart illustrating the logical steps implemented in accord with the present invention to pre-generate triangle tries and triangle inequality index tables prior to executing a query;

FIGS. 8A and 8B show examples of composite distance functions expressed as a parse trie of operators, weights, and other distance functions;

FIG. 9A is a flowchart illustrating details of the logic employed for a preferred implementation of the present invention;

FIG. 9B is a flowchart illustrating the logic for a first subroutine employed in a preferred implementation of FIG. 9A;

FIG. 9C is a flowchart illustrating the logic for a second subroutine employed in a preferred implementation of FIG. 9A;

FIG. 10 is a flowchart illustrating the logic for an alternative embodiment of the first subroutine; and

FIG. 11 is a flowchart illustrating the logic for an alternative embodiment of the second subroutine.

### DESCRIPTION OF THE PREFERRED EMBODIMENT

The present invention exhibits speed, flexibility, and accuracy in implementing a query of a rich database. An exemplary embodiment has been incorporated into a modified FIDS system, and has been tested successfully on a database of more than 37,000 images. It should be noted however, that while this exemplary embodiment has been used to retrieve images from a database, the present invention is not limited to querying images, but instead can be applied to the retrieval of any type of data object, including, but not limited to, sound, video, multimedia, text, spreadsheets, or combinations thereof.

The present invention provides a method for reducing the number of data objects requiring direct comparison with a query object, using triangle tries and the triangle inequality paradigm to increase computational efficiency in a manner not disclosed in the prior art. In the following discussion, techniques are disclosed for applying triangle tries, which are known for providing lower bounds to single distance measurements, to complex combinations of multiple distance measurements. A preferred embodiment uses a two-stage pruning process that employs triangle trie pruning in a first stage and triangle inequality pruning of the results generated by the first stage pruning process. This two-stage method significantly reduces the number of data objects requiring direct comparison with a query object over what could be achieved using the triangle trie and the triangle inequality paradigms independently.

One aspect of the present invention is directed to a method for efficiently employing triangle tries in relatively large database environments. As noted in the Background of the Invention, it is known to employ triangle tries for generalized sub-linear searches for approximate matches with a single distance measure. However, as the size of the triangle trie increases (i.e., for a large database with many key objects), the efficiency of the triangle trie paradigm decreases. Relative to the prior art, the present invention substantially increases the efficiency of triangle tries in large database environments over what was achieved previously.

Note that as the size of a database increases, generally, so does the number of key objects. Since each key object requires an additional level in a triangle trie, for a large database, the triangle trie becomes quite large. In the present invention, the size of the triangle trie is reduced by specifically limiting the number of levels to a pre-defined maximum. The result is a triangle trie that does not fully describe all of the vectors, but which can be rapidly traversed. And, because in a relatively large database environment, the breadth of the levels is likely to be large, analyzing less than all the levels will still generate useful lower bound results. By accepting a partial result, rather than demanding an analysis of a large triangle trie, a significant reduction in the set of data objects to be examined by direct comparison can be rapidly achieved. Requiring an analysis of a large triangle trie leads to diminishing returns, in that with respect to gains in computational efficiency, an incomplete, yet very rapidly obtained result is often more useful than a complete result that requires a much longer time to achieve.

Consider two triangle tries that each reference the same 100,000 database objects and a distance metric d( ), where 25 reference keys have been selected. Assume the first trie uses the full 25 keys, resulting in a depth of 25, while the second triangle trie has a depth of 10. Given a particular query image q, an analysis of the first trie might yield a result that reduces the number of data objects requiring direct comparison from 100,000 to 20,000. An analysis of the second trie under the same conditions might reduce the number of data objects requiring direct comparison from 100,000 to 35,000. However, as the second trie will be analyzed more quickly, it is likely that there will be cases in which using the second trie instead of the first trie will result in an improvement in computational efficiency. That likelihood is further increased when additional reduction paradigms can be rapidly applied to the result obtained by the partial triangle trie.

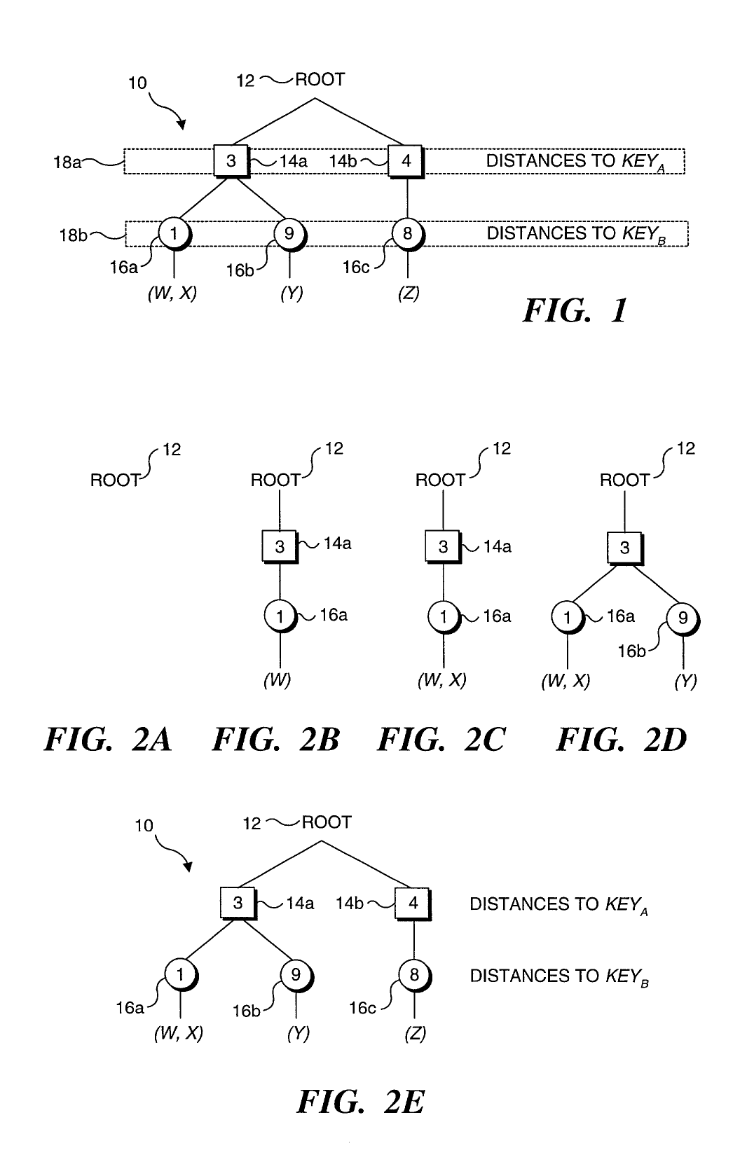

As noted above, triangle tries become less efficient as they grow larger. Thus, in the present invention, a relatively short trie is used, and additional key distances are stored in the leaves. For example, referring to FIG. 1, assume that instead of there being only two key objects (A and B) there are actually 26 key objects (A-Z). Thus, the entire set of vectors for objects W, X, Y, and Z contain 26 elements d(W_{X}, . . . W_{Z}). Triangle trie 10, if fully developed, would include an additional 24 levels, but to increase the speed with which the trie can be pruned, only two levels are analyzed. In a practical sense, as the database is being indexed before any queries, a decision is made as to how many levels to include in the triangle trie, and that trie is pre-generated so that when a query is run, the trie can be quickly pruned.

While in the broadest sense, the number of levels within the triangle trie merely needs to be less than the number of key objects in the present invention, empirical results have indicated several factors that affect the selection of a preferred trie depth. A first observation is that triangle tries having a depth less than three tend to be less efficient. As the depth of a triangle trie increases beyond three levels, the expected number of returned objects decreases, which is desirable. However, the marginal value of each additional level within the trie decreases as the depth of a trie increases, i.e., the time required to analyze each additional level increases.

This decrease in marginal value is caused by two factors. The first factor is that the number of objects referenced by each sub-trie at a level decreases, reducing the effectiveness of an individual pruning action. The second factor is that the trie breadth at each additional level increases up to a maximum equal to the number of database objects referenced by the trie, consuming memory. It is anticipated that a triangle trie having a depth greater than three but less than the number of key objects will be useful. The number of levels less than the number of key objects is likely to vary from database to database, and optimization specific to each database is expected to be beneficial. Those of ordinary skill in the art will readily recognize that optimization techniques are well known, and the selection of an optimum number of triangle trie levels for a specific database is well within the ability of one having ordinary skill in the art.

It should also be noted that selecting a preferred number of key objects from a given set of data objects is also subject to optimization. If too many key objects are selected, the size of triangle tries increases, and the number of vectors relating the distance of each data object to each key object increases. This fact increases the memory required to store index tables, and tends to reduce computational efficiency. If there are too few key objects, pruning does not result in a significant reduction of potential matches, and there is little gain in efficiency. Empirical results obtained using images as data objects indicate that a reasonable number of key objects can be determined by the following functional relationship:

K=log_{(10/7)}(I) (7)

where K is the number of key objects and I is the number of data objects. For a database of 25,000 objects, log_{(10/7)}(25,000)≈28.4. Selecting 29 key objects out of a data set of 25,000 objects should provide a starting point. It is anticipated that a user will adjust this number up or down, based on their understanding of a specific data set.

In a preferred embodiment, the results obtained from pruning the triangle trie are further reduced by employing the triangle inequality and indexed tables, enabling a query to be carried out quite rapidly. Thus, a two-stage pruning process is employed in the present invention.

A flowchart 30 in FIG. 4 shows the sequence of logical steps used in the two-stage pruning process. In a block 32, a user defines a query object, a distance measure (i.e., the characteristic being matched, such as “color”) and a threshold value, for example, find objects within a distance “x” from the query object. Then, in a block 34, the pre-generated short triangle trie for the selected metric is pruned in accord with the user's query. In a block 36, the results generated by pruning the triangle trie are further pruned using the triangle inequality technique and pre-generated index tables. Finally, in a block 38, any data objects not yet eliminated are directly compared to the query object.

A detailed description of the two-stage process is provided below. Given database images I₁, . . . , Iₙ, keys K₁, . . . , Kₘ, and distance measure d, create a triangle trie T of depth T_{depth} where T_{depth}<m. For each stored image Iᵢ, reference Iᵢ in the trie along with d(Iᵢ, Kⱼ) for all K₁, . . . , Kₘ. Given query q, perform a search of the trie as described above. Once completed, calculate lower bounds on the returned images using all the keys, further reducing the size of the returned set.

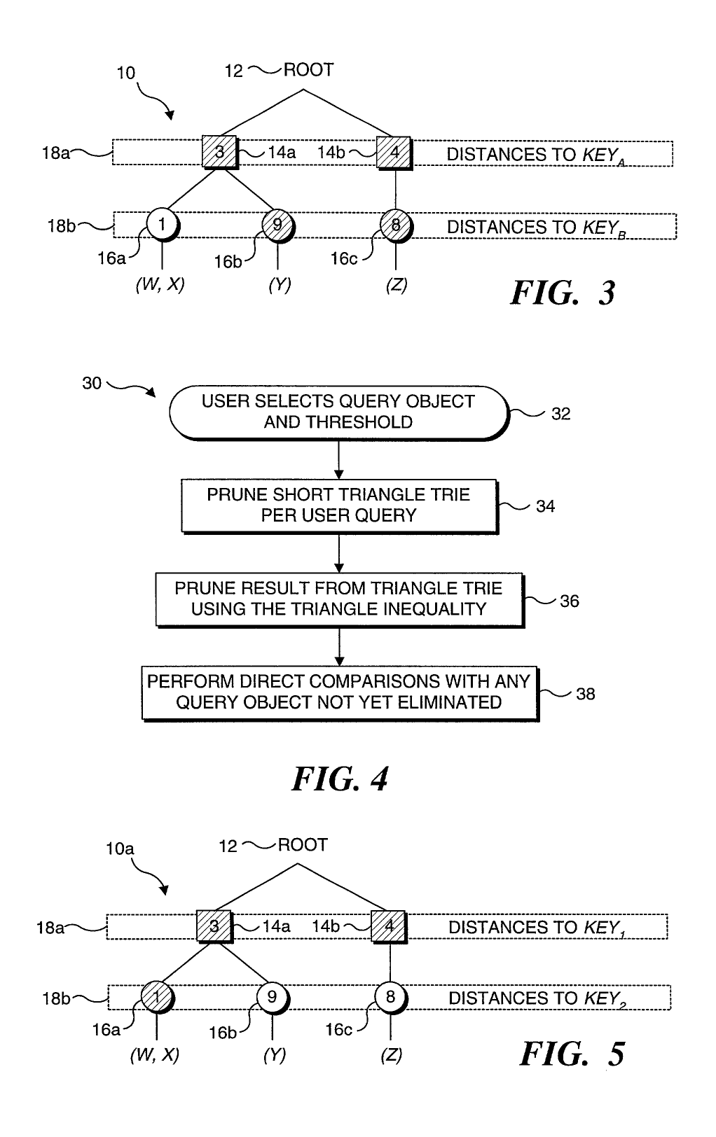

Let S=(W, X, Y, Z) be our objects and (key₁, key₂, key₃, key₄) be the set of keys. Let v_{W}=(3, 1, 7, 2), v_{X}=(3, 1, 4, 5), v_{Y}=(3, 9, 7, 3), and v_{Z}=(4, 8, 5, 2). Note that for each element the distances to key₁ and key₂ are identical to the relationships previously described for trie 10 of FIGS. 1, 2E, and 3. Thus, a trie with a depth of 2, wherein a first-level depth corresponds to key₁ and a second-level depth corresponds to key₂ results in a trie identical to trie 10 (with the exception that key₁ replaces key_{A}, and key₂ replaces key_{B}). Suppose now that it is desired to search the database for a close match to object q where the maximum allowed distance to q is 1. Compute v_{q} as before. Assume that v_{q}=(3, 2, 8, 2). Performing the search as before on the first two keys (key₁ and key₂) returns W and X as potential matches. This search is shown in FIG. 5.

Note that not all keys (key₃ and key₄) have yet been analyzed, and this result is only partial. A better lower bound on the distance from W and X to q requires using all four keys. Since |(v_{W}−v_{q})|=|((3, 1, 7, 2)−(3, 2, 8, 2))|=(0, 1, 1, 1), a lower bound of 1 for the distance from W to V is determined. Since |(v_{X}−v_{q})|=|((3, 1, 4, 5)−(3, 2, 8, 2))|=(0, 1, 4, 3), a lower bound of 4 on the distance from X to V is determined. Thus, this second stage eliminates X from further consideration, leaving only Was a potential match to q.

The above simplistic example involves only four objects (W, X, Y, Z) and relatively short vectors (each vector includes a distance measure to each four keys). It may not appear to be worth the effort to construct a trie to eliminate so few objects, rather than just computing the absolute differences between the vectors of each object and the query object |(vᵢ−v_{q})|. It should be understood that most databases include significantly more than just four objects (more by orders of magnitude), and that tries and indexed tables are generated as the database is assembled or updated, and not at the run-time of a query. As the number of objects increases, the number of keys generally increases as well, making each vector correspondingly larger, and computation of the vectors correspondingly more computationally expensive. At the same time, pre-generated tries and index tables can be examined very rapidly. Thus, the two-stage pruning process described above has significant impact in reducing computational expense when applied to real databases.

As explained above, a triangle trie is designed to enable threshold database searches for a single distance measure, and it is preferable to enable a user to employ multiple distance measures in a search. The present invention enables multiple triangle tries to be used to facilitate threshold database searches over a composite measure. Preferably, a triangle trie is generated for each different distance measure. A distance measure refers to some quantifiable characteristic of the data. For example, if the data is an image, distance measures can include color, texture, shape, etc. Each distance measure will require a separate set of relational vectors. If five different distance measures are defined, then five different sets of relational vectors will be formed for each object in the database, and five triangle tries will be employed.

The two-stage pruning process described above is applied to searches that include more than one distance measure. For each distance measure, a search is done on a different triangle trie. The results from the pruning of each individual trie are either merged or intersected, depending on the particular operation desired by the user, as will be described in more detail below. The multiple trie search and result combination represents the first stage of the two-stage pruning process. The second stage proceeds as before, where the vectors representing any remaining data objects are computationally compared to the query object's vector.

For example, define R(T, Q, t) as the set of images returned from a search on trie T with threshold t. Now consider the composite distance measure d(I, Q)=Min(d₁(I, Q), d₂(I, Q)). Assume the threshold used is t. Let T₁ and T₂ represent the tries associated with d₁ and d₂ respectively. Since d(I, Q)≦T whenever d₁(I, Q)≦t or d₂(I, Q)≦t, all images must be found where d₁(I, Q)≦t or d₂(I, Q)≦t. Thus, one can calculate R(T₁, Q, t) and R(T₂, Q, t) and merge the results. Call this resultant set S′. This set consists of all images i, which have a possibility of being within distance t of Q for a distance measure d. Then, prune S′ with the triangle inequality on the composite function d.

The objective in using the triangle trie is to reduce the number of images for which it is necessary to compute the triangle inequality with the full set of keys. Therefore, when using multiple triangle tries, the objective should be to return as small as possible a set of images that need to be further pruned. In the present invention, processes have been developed for each of the following operations—Min, Max, Sum, and Weight—that reduce the size of the returned set. These operations can be combined to enable the user running a query to select a complex composite distance function, such as “Match on colors, unless the texture and shape are both very close,” or “two out of three of color, texture, and shape must match.”

The Max Function

Given distance functions d₁ and d₂, associated triangle tries T₁ and T₂, query Q, and threshold t, the task is to find all images I such that d(I, Q)≦t where d(I, Q)=Max(d₁(I, Q), d₂(I, Q)). For d(I, Q)≦t to be true, both d₁(I, Q) and d₂(I, Q) must also be true. Thus, the process implemented for the Max function is to calculate R(T₁, Q, t)∩R(T₂, Q, t) by searching on T₁ and T₂ and taking the intersection of the results.

The Min Function

Suppose d=Min(d1, d2). If image I has the property that d(I, Q)≦t, either D₁(I, Q)≦t or d₂(I, Q)≦t must be true. Thus, I must be in R(T₁, Q, t)∪R(T₂, Q, t). To find potential approximate matches to Q in this case, it is necessary to compute the union of the two R functions.

The Addition Function

Suppose d=d₁+d₂ and image I has the property that d(I, Q)≦t. Also, suppose that d₁(I, Q)>v for a given image I and some arbitrary value v. Then, d(I, Q)≦t implies that d₂(I,Q)≦t−v. Thus, d(I, Q)≦t→d₁(I, Q)≦v, d₂(I, Q)≦t−v, for any v. Therefore, I must be in R(T₁, Q, v)∪R(T₂, Q, t−v) for any legitimate 0≦v≦Tt. To find potential approximate matches in this case, pick some value for v and compute the union of the two R functions with the modified thresholds. It is not clear how to efficiently decide the best value for v. Choosing v=0 or v=t has the advantage of eliminating the search of one trie entirely, as well as the consequent merging of results. Yet, there is evidence that halving a threshold more than halves the results that are returned by the query. In a preferred embodiment of the present invention, the subroutine employing this process employs values of v=t=2.

There are other processing possibilities that should be discussed. The relationship SεR(T₁, Q, t)∩R(T₂, Q, t)→sεR(T₁, Q, t) implies that it is possible to simply calculate R(T₁, Q, t) and not bother to calculate R(T₂, Q, t). Similarly, it appears possible to simply compute R(T₂, Q, t). Indeed, it is also possible to compute both and return the smaller set, or their intersection. All of these possibilities will affect the speed of the process, but not the overall accuracy of the results.

The Weight Function

Suppose d=Cd₁ for some positive constant C. Then d(I, Q)≦t implies d₁(I, Q)≦t/C. In this case, find candidates for approximate matches to Q by calculating R(T₁, Q, t/C).

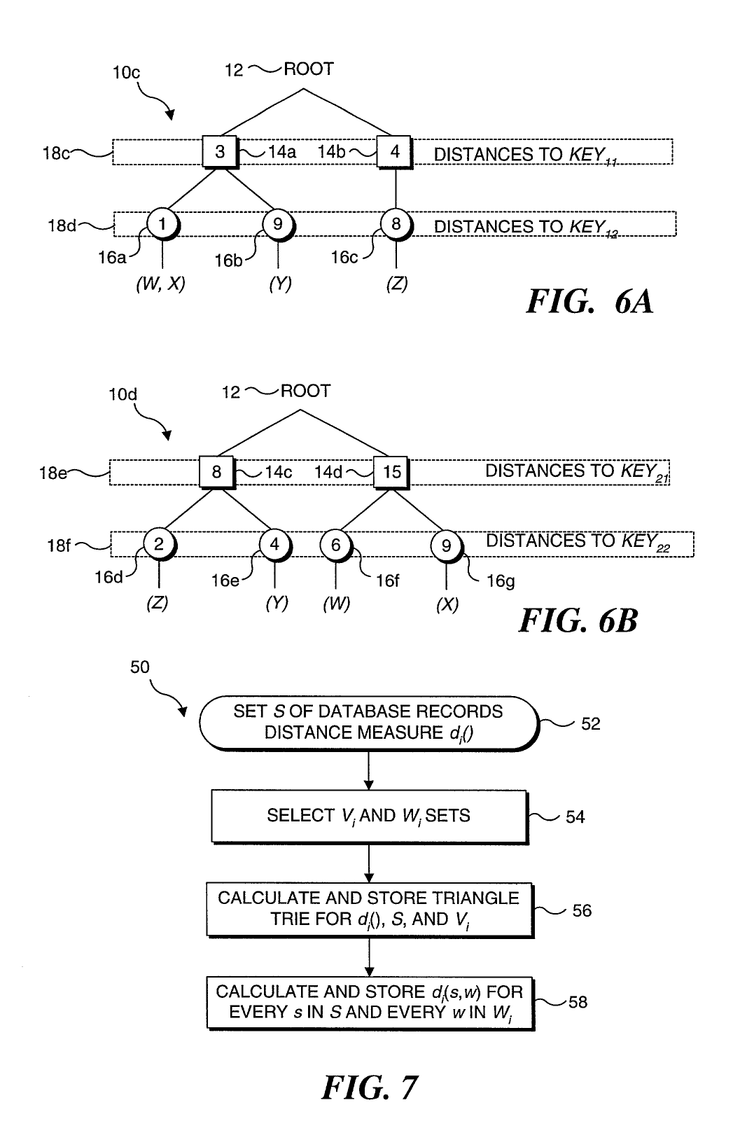

The following section provides an example of using multiple triangle tries for a query that includes multiple distance measures. Given the database S=(W, X, Y, Z) with distance measures d₁ and d₂, let (K₁₁, K₁₂) and (K₂₁, K₂₂) be the keys associated with d₁ and d₂, respectively. Let the triangle tries associated with d₁ and d₂ be as shown in FIGS. 6A and 6B, respectively.

FIG. 6A illustrates a triangle trie 10c with the four elements (W, X, Y, Z) of set S, and two keys (K₁₁, and K₁₂). Note that other than including different keys, triangle trie 10 of FIG. 1 and triangle trie 10c of FIG. 6A appear identical. It should be understood, however, that the triangle tries employed in the present invention will be partial triangle tries, in that not all levels are developed, as opposed to FIG. 1, which represents a fully developed triangle trie. Triangle trie 10c of FIG. 6A includes nodes 14a and 14b in a level 18c (note level 18c is associated with K₁₁), and leaves 16a-16c in a level 18d (note level 18d is associated with K₁₂). As with the related Figures discussed above, each level is indicated by a dashed box, each node is indicated by a square, and each leaf is indicated by a circle.

FIG. 6B illustrates a triangle trie 10d, also with the four elements (W, X, Y, Z) of set S, and two keys (K₂₁ and K₂₂). Triangle trie 10d of FIG. 6B includes nodes 14c and 14d in a level 18e (note level 18e is associated with K₂₁), and leaves 16d-16g in a level 18f (note level 18f is associated with K₂₂).

Now consider a query Q. Assume that it is desired to find close matches to Q with distance measure d′=Max(d₁, d₂) and with threshold t=2. Suppose that in computing the distance from Q to (K₁₁, K₁₂) using distance measure d₁, the results obtained are (3, 8). Furthermore, computing the distance from Q to (K₂₁, K₂₂) using distance measure d₂, yields (15, 8). Searching the trie associated with d₁ produces element Y as a potential match. Searching the trie associated with d₂ yields elements (W, X) as a potential match. Since the Max function is being used, the intersection of the returned sets can be computed. The intersection of (Y) and (W, X) is empty. Thus, no images are returned as potential matches to Q.

Continuing with the same example, assume that the distance measure d′=d₁+d₂ had been used with threshold t=2. Following the procedure for the addition of functions outlined above, a value of v=t/2=1 is chosen, resulting in threshold values of 1 for each triangle trie. Searches are performed as before, but with a threshold t=1 on each trie. As before, the element Y is obtained as a potential match from the first trie, but the reduced threshold results in only X returned as a potential match from the second trie. Since the addition function is being used, the union of the returned sets is computed. Thus, images Y and X are returned as potential matches to Q. In the case of d′=Min(d₁, d₂), (W, X, Y) would be returned as potential matches to Q.

In a preferred embodiment of the present invention, combinations of short triangle tries and triangle inequality indexed tables are used for optimal pruning performance. Let S={ s₁, . . . , sₙ} represent the set of records in the database. Let D={d₁( ), . . . , dₚ( )} be a set of distance measures programmed into the system. This set of measures will be the basis for construction of new distance measures by a user when the query is run. Let U represent the domain of the records to be indexed by the system. That is, sᵢεU for every 1≦i ≦n and every Dᵢ( ) operates on elements of U for 1≦i≦p. Essentially, U is simply the domain of all objects for which the present invention can calculate distances to other objects.

Given the above set of records, preferably, before a user is enabled to execute a search, triangle tries and index tables are generated and stored for quick retrieval and analysis when the query is run. A flowchart 50 in FIG. 7 shows the sequence of logical steps used to prepare the database for efficient searches based on the use of triangle tries and the triangle inequality technique, as described above. In a block 52, the set of database objects and distance measures are defined. Then, in a block 54, for each distance measure dᵢ, two positive numbers vᵢ and wᵢ are selected, and two sequences of elements of U, Vᵢ, and Wᵢ, are generated. Set Vᵢ has vᵢ elements and Wᵢ has wᵢ elements. In the next step in a block 54, the system calculates the distance from every element of S to every element of Vᵢ and stores these distances in a triangle trie. The depth of the triangle trie is vᵢ. Let Tᵢ be the name for the triangle trie created for distance measure Dᵢ( ). Then in a block 58, the system also calculates and stores the distance from every element of S to every element of Wᵢ using Dᵢ( ) as the distance measure. The distances calculated for element sεS can either be stored in the leaf of the triangle trie with the reference to s, or in a table. The two numbers vᵢ and wᵢ can be chosen in an arbitrary fashion by the system, and the sequences Vᵢ and Wᵢ can also be created arbitrarily. For example, they could be taken randomly from the set S, and they may have elements in common.

In a preferred embodiment of the present invention, the two-stage pruning process and the step of enabling a user to combine distance measures in complex combinations are combined to provide a system adapted to search a database in response to a query by a user. Preferably this system is activated when it is presented with the following three items: a query record Q, a threshold t, and a composite distance function d′( ). Following is a further description of these inputs:

query record Q: The query record is an object for which the operator wishes to find close matches.

Threshold t: The threshold is a non-negative numerical value. A database record is not considered a sufficiently close match by the operator if the distance from the query record to the database record is beyond the threshold. That is, using composite distance function d′( ), a record sεS is not returned by the system if d(s, Q)>t is true. The threshold may be arbitrarily high, or set so high (infinite value) that all of the records will be returned.

Distance function d′( ): Composite distance function d′( ) is preferably represented as an abstract data type known as a parse trie. Each internal node of the trie contains two tokens—a non-negative value called a weight, and one of three operator tokens sum, min, and max. Each leaf of the trie contains two tokens—a non-negative weight and a reference to one of the distance measures in D.

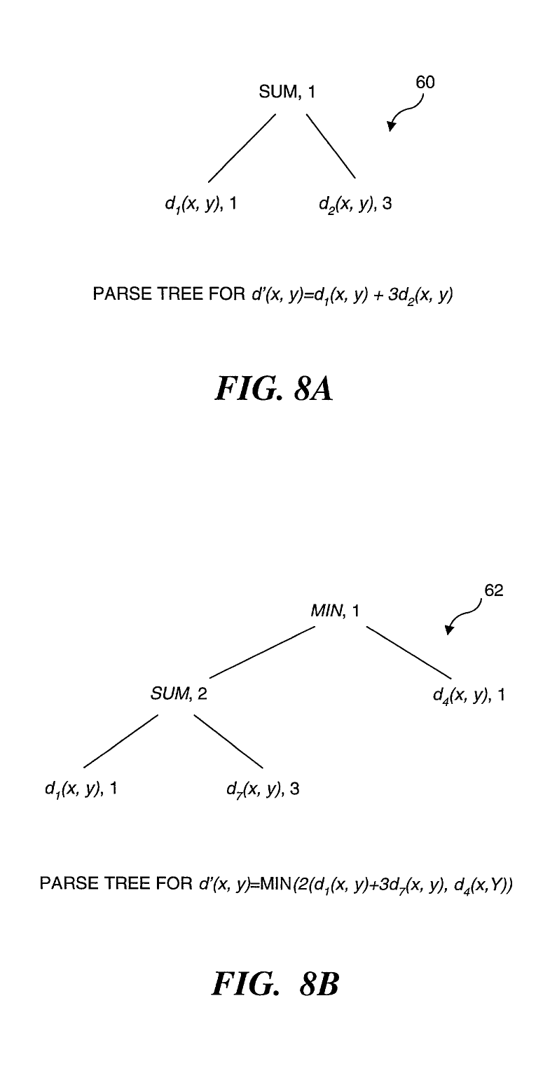

FIGS. 8A and 8B illustrate two examples of parse tries. In FIG. 8A, a parse trie 60 is provided for the composite function d′(x, y)=d₁(x, y)+3d₂(x, y), while in FIG. 8B a parse trie 62 describes the more complicated function d′(x, y)=min(2(d₁(x, y)+3d₇(x, y)), d₄(x, y)). The purpose of the parse trie format is to enable the composite distance measure to be broken down into its constituent base distance measures, enabling the system to use the method described above. Each constituent base distance measure is described by a short triangle trie as described above. The parse tries of FIGS. 8A and 8B illustrate how the base distance measures (hence, the results of the analysis, or pruning of specific triangle tries) are combined according to the query defined by a user.

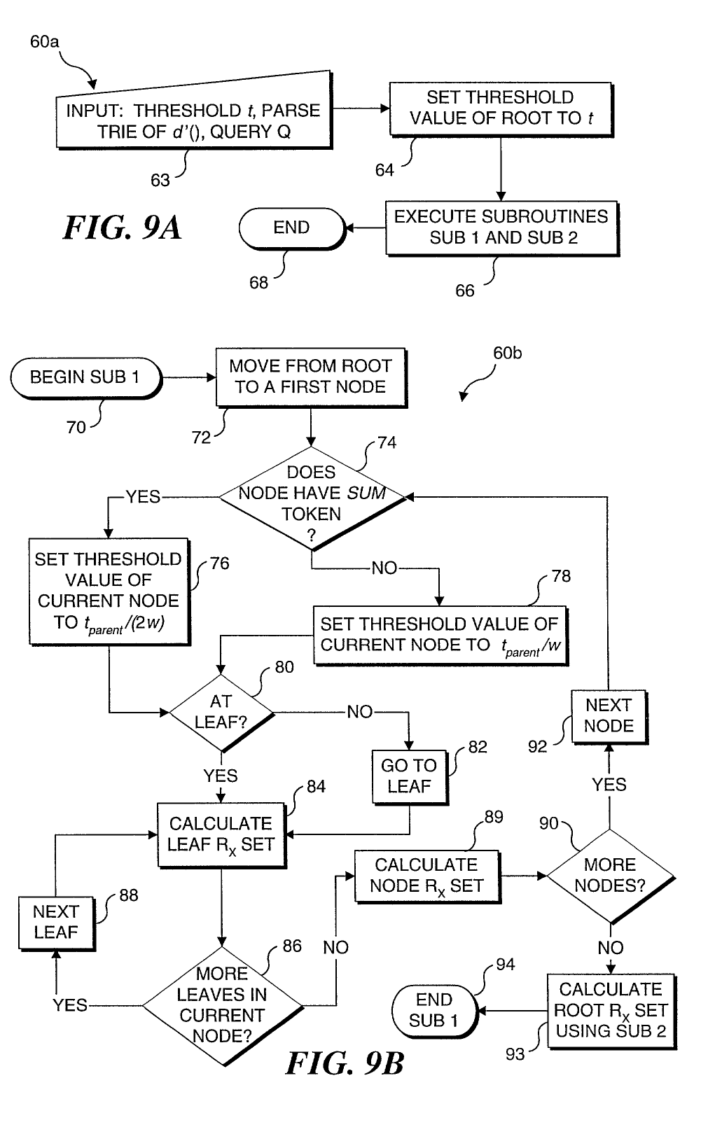

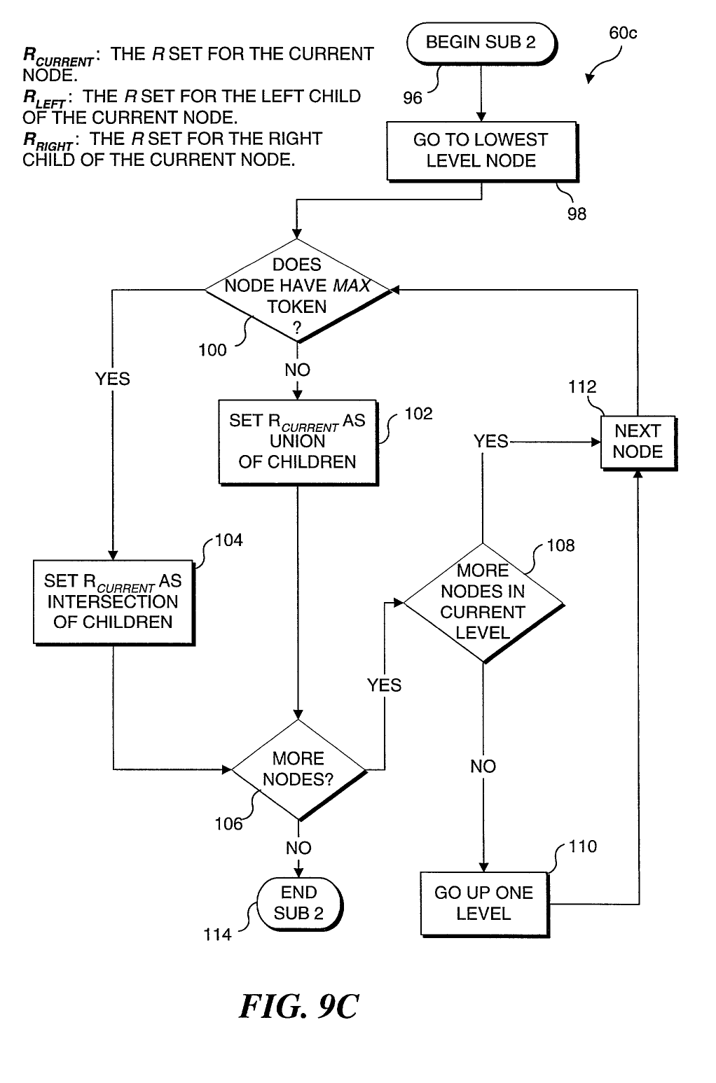

FIGS. 9A, 9B, and 9C illustrate flowcharts describing the operation of a preferred system that employs the two-stage pruning process and complex distance measures detailed above. A flowchart 60a in FIG. 9A shows the sequence of logical steps used to by the system to process a complex distance measure as defined by a parse trie for d′( ) (see FIGS. 8A and 8B). If the query defines only a single distance measure, the system employs the logical steps described in flowchart 30 of FIG. 4. However, it is anticipated that most user queries will be a combination of multiple distance measures.

In a block 63 of FIG. 9A, a user defines a query by selecting and inputting a threshold value, a query object, and the combination of distance measures. In a block 64, the system sets the threshold value of the root to t. Next, the system determines the parse trie (for example, FIG. 8A or 8B) that describes the combination of distance measures in the query. In a block 66, the logic “walks” the parse trie of d′( ), beginning at the root. As each internal or leaf node in the parse trie is reached, a local threshold value is calculated using a subroutine SUB 1, such that each child of the root is analyzed. Subroutine SUB 1 is described in detail in a flowchart 60b in FIG. 9B. After Subroutine SUB 1 is completed, flowchart 60a terminates at an end block 68.

Flowchart 60b of FIG. 9B begins in a start block 70. Next, the logic advances from the root to a first node in a block 72. In a decision block 74, the system determines if a parent of the current parse trie node includes a sum token (the other possibility is that the parent includes a min or max token). If the parent contains a sum token, the logic proceeds to a block 76 and the value of the current node is set equal to tₚₐᵣₑₙₜ/(2w), where w is the weight token of the current node and tₚₐᵣₑₙₜ is the threshold value of the parent node. The logic then moves to a decision block 80, and the system determines if the current location in the parse trie is a leaf (the other possibility being that the current location is a node). If the current location is a leaf, then the logic calculates a set of records in a block 84, as described in more detail below.

Returning to decision block 74, if the system determines that the parent of the current parse trie node does not include a sum token (i.e., that it includes a min or max token), the logic proceeds to a block 78, and the value of the current node is set equal to tₚₐᵣₑₙₜ/w, where w is the weight token of the current node and tₚₐᵣₑₙₜ is the threshold value of the parent node. The logic then moves to decision block 80 and determines if the current node is a leaf. If the current node is a leaf, the logic proceeds to block 84 and calculates a set of records. If, in decision block 80, the logic determines that the current position is not a leaf (i.e., that the current position is a node), then the logic moves to a leaf in a block 82. The logic then proceeds to the calculation step of block 84.

The calculation of block 84 is performed as follows. Note that each leaf has a reference to one of the distance measures in D. Let d_{X} be the distance measure referenced in leaf X. As leaf X is reached in block 84, the system uses Q. t_{X}, and the pre-calculated triangle trie for distance measure d_{X} to calculate a subset of records from S. This subset of records is labeled R_{X}. Let t_{X} be the local threshold value calculated at node X. This local value is calculated as follows.

If the current leaf is the child of a node with a min token or max token, the value is equal to tₚₐᵣₑₙₜ/w, where w is the weight token of the current node and tₚₐᵣₑₙₜ is the threshold value of the parent node (this step occurs in block 78).

If the current leaf is the child of a node with a sum token, set the threshold value of current node to tₚₐᵣₑₙₜ/(2w), where w is the weight token of the current node and tₚₐᵣₑₙₜ is the threshold value of the parent node (this step occurs in block 76).

Once the calculation is performed in block 84, the logic proceeds to a decision block 86 and determines if there are any more leaves related to the current node. If there are more leaves parented by the current node, the logic advances to a next leaf in a block 88. The logic then returns to block 84 and performs the above calculation on the now current leaf. If in decision block 86 the logic determines that no more leaves are related to the current node, the logic moves to a block 89 and a set is calculated for the current node. If the current node has a min or sum token, then the records of the two children (the leaves) are merged to form the set for the current node. If the current node has a max token, then the records of the two children (the leaves) are intersected to form the set for the current node.

Once the set for the current node is calculated in block 89, the logic then determines if there are more nodes in a decision block 90. If more nodes are present, the logic moves to the next node in a block 92. At this point, the logic returns to decision block 74 to determine if the now current node includes a sum token, or a min/max token.

Eventually, a set of records R_{X} will be calculated for each leaf in the parse trie. Sets of records are then calculated for each internal node in the parse trie. Note that no set is calculated for a node until the sets for the node's children are first calculated, that if the current node has a min or sum token, then the records of the two children are merged to form the set for the current node, and if the current node has a max token, then the records of the two children are intersected to form the set for the current node.

Referring once again to decision block 90, if the system determines that no nodes remain to be examined, the logic proceeds to a block 93, and subroutine SUB 2 will create a set of records for the root of the parse trie. The system then sends set R to the user as the output. Subroutine SUB 1 is now complete, as shown in a block 94.

A flowchart 60c in FIG. 9C illustrates the series of logical steps performed when subroutine SUB 2 of block 93 in FIG. 9B is executed. The overall logic for Subroutine Sub 2 is to generate the set Rᵣₒₒₜ. As noted above, the system will have pre-calculated the distances from all of the S to all of the Wᵢ sets using the appropriate distance measures. Using the procedure described above, the system uses these values along with d′( ), Q, and Rᵣₒₒₜ, to calculate a lower bound on the d′( ) distance from every record sεRᵣₒₒₜ to Q. Starting with an empty set R, the system inserts in set R a reference to every record sεRᵣₒₒₜ, which has a calculated lower bound that is not greater than t. Set R is then sorted in order of increasing calculated lower bounds.

Referring to flowchart 60c in FIG. 9C, subroutine Sub 2 is initiated in a block 96. The logic then proceeds to a block 98, and the system sets the current node as a node on the lowest level of the parse trie. In a decision block 100, the logic determines if the current node includes a max token. If so, R_{CURRENT} is assigned as the intersection of the R sets determined for the children (the left and right leaves) of the current node in a block 104. If in block 100 the logic determines that the current node does not include a max token (i.e., it includes a min or sum token), then R_{CURRENT} is assigned as the union of the R sets determined for the children (the left and right leaves) of the current node, as shown in a block 102.

The logic then proceeds to a decision block 106, and the system determines if there are any unexamined nodes. If not, subroutine SUB 2 is finished in an end block 114. If in decision block 106, the system determines that there are more nodes, the logic moves to a decision block 108, and the system determines if any unexamined nodes exist on the current level. If so, the logic moves to a block 112, and the next node is selected as the current node. If in decision block 108, the system determines that no other nodes are yet to be examined in the current level, the logic moves up one level, in a block 110. The logic then moves to block 112, and the next node is selected as the current node. From block 112, the logic loops back to decision block 100, and the process is repeated until the root set is fully determined. Note that when SUB 2 is completed, the logic returns back to flowchart 60b of FIG. 9B, at block 94.

It should be understood that while the preceding discussion represents a preferred embodiment of the present invention, modifications can be made that provide other combinations of triangle tries and triangle inequality relationships to reduce the set of data records that need be directly compared with a query data object. The preferred embodiment should therefore be considered as exemplary, rather than as limiting.

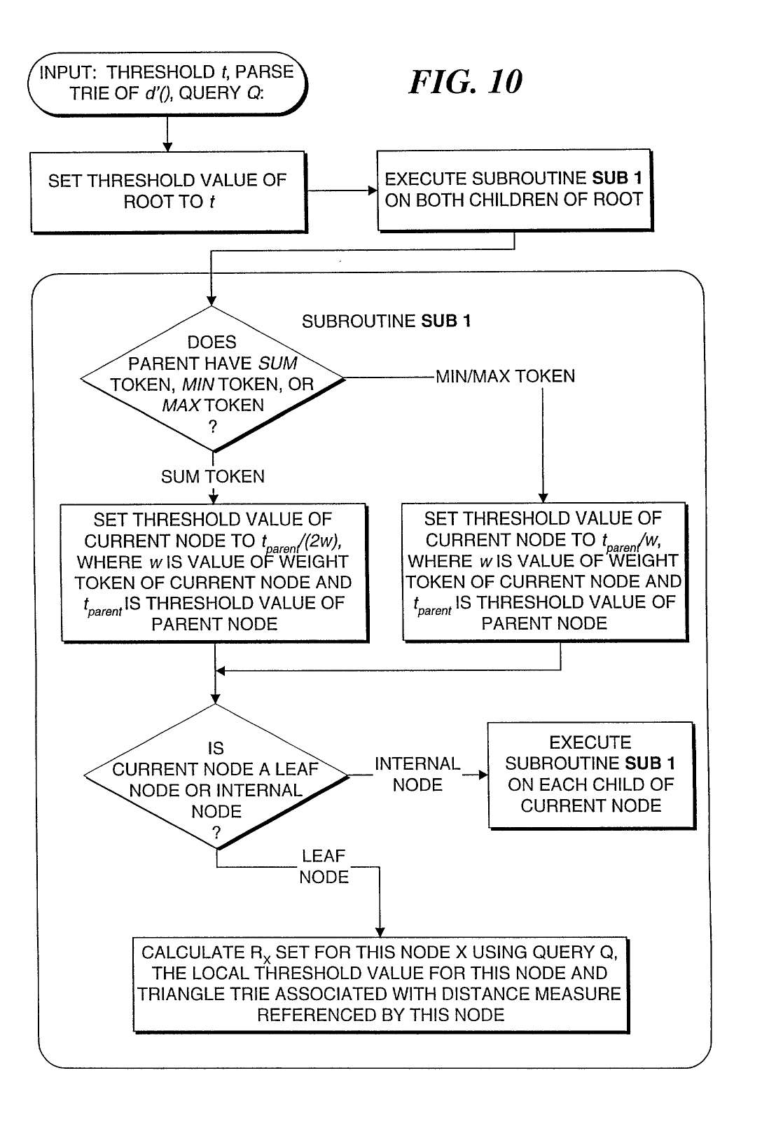

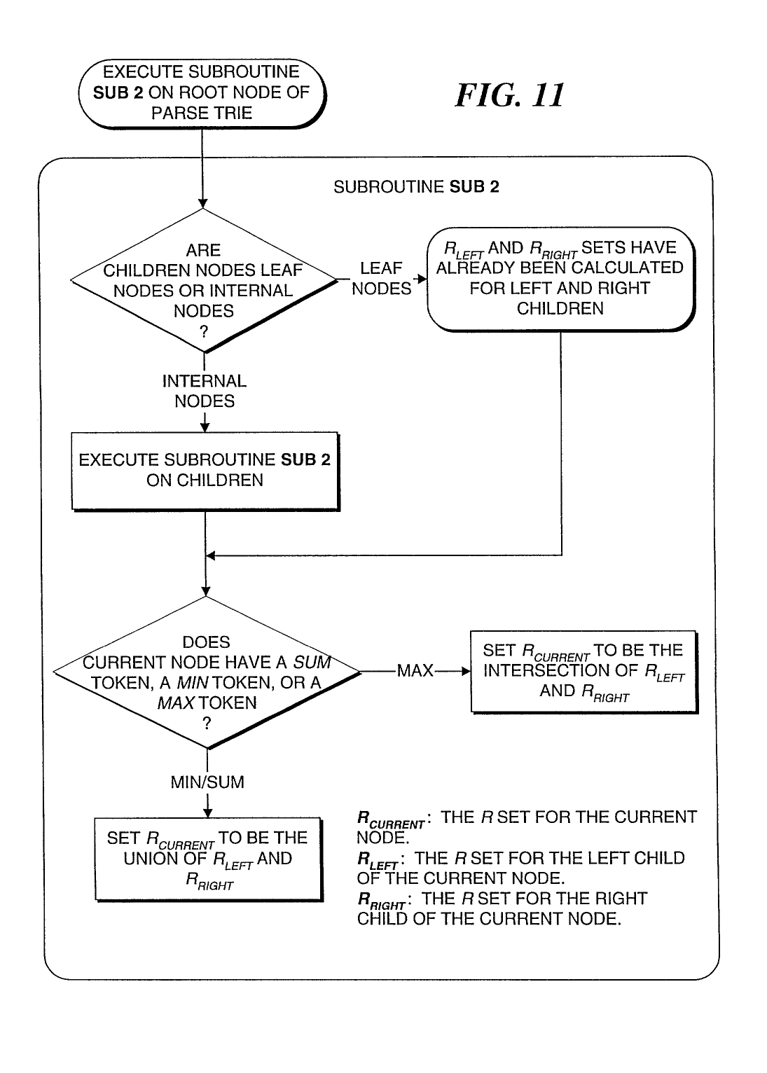

For example, the series of logical steps described in FIGS. 9B and 9C for Subroutines SUB 1 and SUB 2 can be interleaved in a variety of ways as data are created. FIGS. 10 and 11 illustrate the functional steps used in such subroutines, but the details of these individual steps are not discussed herein, since these routines are simply exemplary.

In the embodiment described above, local threshold values are calculated as the invention traverses the parse trie. Specific equations have been provided above for use in calculating local threshold values. However, the numbers obtained from these calculations are lower bounds. Any calculation that yields a number not less than the one given by the equations can be used instead of the original equations to create local threshold values. This approach may be useful in cases where the threshold values need to be rounded up to an integer.

For example, during local threshold calculation in the present invention, the children nodes X and Y of a node with a sum token receive a local threshold value of tₚₐᵣₑₙₜ/2w_{X}, where w_{X} is the weight token of node X and w_{Y} is the weight token of node Y. In an alternate embodiment, the two children nodes X and Y receive local threshold values of ctₚₐᵣₑₙₜ/w_{X} and (1−c)tₚₐᵣₑₙₜ/w_{Y} respectively, where 0≦c≦1.

Another anticipated variation relates to the calculation of the set R, where as described above, child node sets are merged at the parent node if the parent node has a sum token. Instead, in an alternative embodiment, the two child nodes X and Y receive local threshold values of tₚₐᵣₑₙₜ/w_{X} and tₚₐᵣₑₙₜ/W_{Y}. If this step is taken, child node sets of a parent node with a sum token can be intersected rather than merged. Because the system exhibits better performance with a smaller set R, this alteration may be useful in the case that one of the child node sets is expected to be much smaller than the other one.

Where two sets R_{X} and R_{Y} are intersected to form a new set, one set can simply be discarded rather than intersected. This approach may be advantageous in cases where the intersection is time consuming and not likely to result in a significant reduction in the size of the resultant set compared to just using one of R_{X} or R_{Y}. The two sets may also be merged, but this option is normally not a preferable alternative.

Although the present invention has been described in connection with the preferred form of practicing it and modifications thereto, those of ordinary skill in the art will understand that many other modifications can be made thereto within the scope of the claims that follow. Accordingly, it is not intended that the scope of the present invention in any way be limited by the above description, but instead be determined entirely by reference to the claims that follow.

The invention in which an exclusive right is claimed is defined by the following:

1. A method for identifying any data object in a set of data objects that matches a query data object within a defined limit, said method comprising the steps of:
(a) determining:
(i) a set of key objects in the set of data objects;
(ii) a set of relational vectors, such that for each data object in the set of data objects, a relational vector describes at least one type of distance measure between that data object and each key object in the set of key objects; and
(iii) a triangle trie for each different type of distance measure that is defined, each triangle trie having a number of levels that is less than a number of key objects in said set of key objects;
(b) enabling a user to select a query object and to select at least one type of distance measure that will be used to match a data object from the set of data objects to said query object;
(c) determining a query relational vector for said query object, such that said query relational vector describes a distance measure between said query object and each key object for each type of distance measure selected;
(d) for each triangle trie related to a distance measure selected by a user, pruning that triangle trie to produce a potentially matching set of data objects from which any data objects that cannot match said query object within the defined limit have been eliminated, thereby reducing a number of data objects in the potentially matching set that potentially will require direct comparisons with said query object; and
(e) directly comparing data objects from said set of data objects that have not yet been eliminated to identify any data object that matches the query data object within the defined limit.

2. The method of claim 1, wherein the step of determining comprises the steps of identifying:
(a) more than three key objects; and
(b) at least three levels in each triangle trie.

3. The method of claim 1, wherein the step of enabling a user to select at least one type of distance measure comprises the step of enabling a user to formulate a query based on a combination of distance measures.

4. The method of claim 3, wherein the step of enabling a user to formulate a query based on a combination of distance measures comprises the steps of:
(a) enabling a user to include within a query a summation function that is applied to at least two different distance measures selected by the user, said at least two different distance measures each having a corresponding triangle trie; and
(b) applying the summation function to each potentially matching set resulting from pruning each of the corresponding triangle tries from the preceding step to produce a single potentially matching set of data objects.

5. The method of claim 4, wherein the step of enabling a user to formulate a query based on a combination of distance measures further comprises the step of enabling a user to form a query that includes a maximum function applied to at least two different distance measures, such that the potentially matching sets resulting from pruning each triangle trie corresponding to the at least two different distance measures are merged together by determining an intersection of the potentially matching sets, producing a single potentially matching set of data objects, to further reduce the number of data objects included in the single potentially matching set potentially requiring direct comparisons with said query object.

6. The method of claim 4, wherein the step of enabling a user to formulate a query based on a combination of distance measures further comprises the step of enabling a user to form a query that includes a minimum function applied to at least two different distance measures, such that the potentially matching sets resulting from pruning each triangle trie corresponding to the at least two different distance measures are merged together by taking a union of the results, data objects corresponding to said union of the results being eliminated from the number of data objects that potentially will require direct comparison with said query object, to further reduce said number.

7. The method of claim 4, wherein the step of enabling a user to formulate a query based on a combination of distance measures further comprises the step of applying a weighting function to at least one distance measure, such that the potentially matching sets resulting from pruning each triangle trie to which the weighting function is applied are compared to said query object based on the weighted match selected by the user.

8. The method of claim 1, further comprising the step of enabling the user to select the defined limit.

9. The method of claim 1, further comprising the steps of:
(a) applying a triangle inequality technique to each relational vector corresponding to a data object in said potentially matching set and said query relational vector, to determine a lower bound for each distance measure between each data object in said potentially matching set and said query object; and
(b) eliminating any data object from said potentially matching set of data objects whose lower bound exceeds said defined limit, thereby further reducing a number of data objects that will require direct comparisons with said query object.

10. The method of claim 9, further comprising the step of creating index tables describing the distance measure relationships between each data object and each key object prior to a time at which the user selects the query object, said step of applying a triangle inequality technique to each relational vector corresponding to a data object in said potentially matching set, and said query relational vector comprising the step of applying the triangle inequality technique to said query relational vector and data contained in said index tables corresponding to each data object in said potentially matching set, earlier creation of the index tables reducing a computational time required to apply said triangle inequality technique to each relational vector.

11. A method for identifying any database objects that substantially match a specified query object in a computationally efficient manner in which a number of direct comparisons required to identify any database objects that substantially match said query object is reduced, comprising the steps of:
(a) identifying a set of key objects in a database having a plurality of database objects;
(b) generating a plurality of relational vectors, such that for each database object, a relational vector describes at least one type of distance measure between the database object and each key object;
(c) generating a triangle trie for each different type of distance measure, each triangle trie having a number of levels that is less than a number of key objects in said set of key objects;
(d) enabling a user to select a query object and at least one type of distance measure that will be used to match a data object to said query object, and to define a degree of closeness with which matches between data objects and said query object are to be evaluated;
(e) determining a query relational vector for said query object for each distance measure, such that a query relational vector describes a distance measure between said query object and each key object for each type of distance measure selected by the user;
(f) for each triangle trie related to a distance measure selected by the user, pruning that triangle trie to eliminate from consideration any database objects that cannot match said query object within at least the degree of closeness defined by the user, thereby creating a subset of data objects in which a number of database objects that potentially will require direct comparisons with said query object has been reduced;
(g) for each data object in said subset of data objects, applying a triangle inequality technique to further reduce the number of data objects that potentially will require direct comparison with said query object; and
(h) directly comparing any database objects not yet eliminated from consideration with said query object to identify the database objects that match said query object within at least the degree of closeness defined by the user.

12. A method for reducing a number of direct comparisons required to identify any data object in a set of data objects that matches a query data object, said method comprising the steps of:
(a) determining a set of key objects and a set of relational vectors, such that for each data object a relational vector describes at least one type of distance measure between that data object and each key object;
(b) generating a triangle trie for each different type of distance measure provided, each triangle trie having a number of levels that is less than a number of key objects in said set of key objects;
(c) generating index tables including data from said set of relational vectors;
(d) enabling a user to select a query object and at least one type of distance measure that will be used to match a data object to said query object;
(e) in response to determining said query object, determining at least one query relational vector, such that a different query relational vector describes a distance measure between said query object and each key object for each type of distance measure selected;
(f) pruning each triangle trie that is related to a distance measure selected by a user to eliminate from further consideration any data objects from said set of data objects that cannot match said query object, thereby reducing a number of data objects that potentially will require direct comparisons with said query object;
(g) using the data included in said index tables and the query relational vectors, applying a triangle inequality technique to further reduce the number of data objects that potentially will require direct comparison with said query object; and
(h) directly comparing to said query object any data object remaining for direct comparison following the preceding two steps.

13. A method for identifying database records that are close matches to a specified query object in a computationally efficient manner, by reducing a number of direct comparisons required to identify any database record that closely matches said query object, said method comprising the steps of:
(a) providing a database comprising a plurality of database records;
(b) defining a first subset of said plurality of database records as key objects, such that the subset of key objects contains less than all of said database records;
(c) defining a plurality of distance measures, each distance measure corresponding to a quantifiable characteristic of a data type stored in said plurality of database records;
(d) generating a plurality of relational vector sets, such that for each different distance measure a relational vector set is generated, each relational vector set comprising a distance measure between each database record and each key object;
(e) generating a plurality of triangle tries, such that for each different distance measure a triangle trie is generated, each triangle trie having less than one level for each key object;
(f) enabling a user to select a query object, to select at least one of said plurality of distance measures for determining a match with a database record, and to define a degree of closeness by at least which identified database records should match said query object;
(g) generating at least one query relational vector set, such that for each different distance measure selected by a user a query relational vector set is generated, each query relational vector set comprising a distance measure between said query object and each key object;
(h) pruning each triangle trie associated with a distance measure selected by a user to eliminate from further consideration any database records that cannot match said query object within at least the degree of closeness defined by a user, to produce a second subset of database records, said second subset comprising any database records not yet eliminated from consideration, thereby reducing a number of database records that potentially could match said query object;
(i) applying a triangle inequality technique to each query relational vector set and each relational vector corresponding to a database record in said second subset of database records to eliminate from further consideration any database records that cannot match said query object within at least the degree of closeness defined by a user, thus generating a third subset of database records, said third subset comprising any database records not yet eliminated from consideration, thereby further reducing the number of data objects that potentially will require direct comparison with said query object; and
(j) directly comparing any database record in said third subset with said query object to identify the database records that match said query object within at least the degree of closeness defined by the user.

14. The method of claim 13, further comprising the step of indexing the plurality of relational vector sets to generate at least one table before enabling a user to select a query object, wherein the step of applying a triangle inequality technique to each query relational vector set and each relational vector comprises the step of utilizing said at least one table to reduce an amount of computational time required to apply said triangle inequality technique.

15. The method of claim 13, wherein the step of defining a first subset of said plurality of database records as key objects comprises the step of defining more than three database records as key objects, such that each triangle trie includes at least three levels.

16. The method of claim 13, wherein the step of enabling a user to select a query object and to define a degree of closeness comprises the step of enabling a user to formulate a query based on a combination of distance measures.

17. The method of claim 16, wherein the step of enabling a user to formulate a query based on a combination of distance measures comprises the step of enabling a user to formulate a query that includes a summation function applied to at least two different distance measures, such that data records not eliminated from further consideration by pruning each triangle trie corresponding to the at least two different distance measures to which the summation function is applied are summed together to generate said second subset.

18. The method of claim 16, wherein the step of enabling a user to formulate a query based on a combination of distance measures comprises the step of enabling a user to form a query that includes a maximum function applied to at least two different distance measures, such that data records not eliminated from further consideration by pruning each triangle trie corresponding to the at least two different distance measures to which the maximum function is applied are merged together by taking an intersection of the data records not eliminated from further consideration by pruning each triangle trie corresponding to the at least two different distance measures to which the maximum function is applied, said intersection then being used to generate said second subset.

19. The method of claim 16, wherein the step of enabling a user to formulate a query based on a combination of distance measures comprises the step of enabling a user to form a query that includes a minimum function applied to at least two different distance measures, such that data records not eliminated from further consideration by pruning each triangle trie corresponding to the at least two different distance measures to which the minimum function is applied are merged together by taking a union of the data records not eliminated from further consideration by pruning each triangle trie corresponding to the at least two different distance measures to which the minimum function is applied, said union then being used to generate said second subset.

20. An article of manufacture adapted for use with a computing device to enable a user to rapidly identify any data object in a set of data objects that matches a query data object to within at least a degree of closeness selectable by a user, by reducing a number of direct comparisons required to identify any matching data objects, comprising:
(a) a memory medium; and
(b) a plurality of machine instructions stored on the memory medium, said plurality of machine instructions, when executed by a processor in a computing device, causing the processor to:
(i) define a key object subset of said data objects;
(ii) determine a set of relational vectors, such that for each data object a relational vector describes at least one type of distance measure between that data object and each key object;
(iii) generate a triangle trie for each different type of distance measure provided, each triangle trie having a number of levels that is less than a number of key objects in said key object subset;
(iv) index said set of relational vectors, such that said set of relational vectors can be accessed rapidly;
(v) enable a user to select a query object, to select at least one type of distance measure that will be used to match a data object to said query object, and to select a degree of closeness by at least which identified data objects should match said query object;
(vi) determine at least one query relational vector for said query object, such that a query relational vector describes a distance measure between said query object and each key object for each type of distance measure selected;
(vii) prune each triangle trie related to a distance measure selected by a user to eliminate from further consideration any data objects from said set of data objects that cannot match said query object within at least said degree of closeness selected by a user, thereby reducing a number of data objects that potentially will require direct comparisons with said query object;
(viii) for each data object in said set of data objects that has not yet been eliminated, retrieving a corresponding relational vector from the index of said set of relational vectors, and employing a triangle inequality technique to further eliminate data objects that cannot match said query object to within at least said degree of closeness selected by a user; and
(ix) directly comparing to said query object any data object not yet eliminated from consideration, thereby identifying any data object in said set of data objects that matches said query data object to within at least said degree of closeness selected by a user.

21. The article of manufacture of claim 20, wherein said key object subset comprises more than three data objects, such that each triangle trie includes at least three levels.

22. The article of manufacture of claim 20, wherein a user is enabled to formulate a query based on a combination of distance measures.

23. The article of manufacture of claim 22, wherein said combination of distance measures comprise at least one of:
(a) a summation function applied to at least two different distance measures, such that data objects not eliminated from further consideration by pruning each triangle trie corresponding to the at least two different distance measures to which the summation function is applied are summed together to generate a summation subset of data objects that potentially match said query object within at least the degree of closeness selected by a user;
(b) a maximum function applied to at least two different distance measures, such that data objects not eliminated from further consideration by pruning each triangle trie corresponding to the at least two different distance measures to which the maximum function is applied are merged together by taking an intersection of the data objects not eliminated from further consideration by pruning each triangle trie corresponding to the at least two different distance measures to which the maximum function is applied, said intersection thus producing an intersection subset of data objects that potentially match said query object within at least the degree of closeness selected by a user; and
(c) a minimum function applied to at least two different distance measures, such that data objects not eliminated from further consideration by pruning each triangle trie corresponding to the at least two different distance measures to which the minimum function is applied are merged together by taking a union of the data objects not eliminated from further consideration by pruning each triangle trie corresponding to the at least two different distance measures to which the minimum function is applied, said union thus representing a union subset of data objects that potentially match said query object within at least the degree of closeness selected by a user.

24. A system for enabling a user to rapidly identify database records that are close matches to a specified query record in a computationally efficient manner, by reducing a number of direct comparisons required to identify any database record that closely matches said query record, comprising:
(a) a memory in which are stored:
(i) a plurality of machine instructions;
(ii) a database comprising a plurality of database records;
(iii) a set of key objects comprising a portion of said plurality of database records;
(iv) an indexed set of relational vectors, such that for each database record a relational vector describes at least one type of distance measure between that data object and each key object; and
(v) a triangle trie for each different type of distance measure provided, each triangle trie having a number of levels that is less than a number of key objects in said set of key objects; and index tables describing said set of relational vectors;
(b) a display; and
(c) a processor that is coupled to the display and to the memory to access the machine instructions, said processor executing said machine instructions and implementing a plurality of functions, including:
(i) enabling a user to select a query object and to define how closely identified database records should match said query object;
(ii) generating at least one query relational vector set, such that for each different distance measure a query relational vector set is generated, each query relational vector set comprising a distance measure between said query object and each key object;
(iii) pruning each triangle trie to eliminate from further consideration any database records that cannot match said query object at least as closely as defined by a user, thereby reducing a number of database records that potentially could match said query object;
(iv) using the indexed plurality of relational vector sets, the at least one query relational vector set and a triangle inequality technique to eliminate from further consideration any database records not previously eliminated that cannot match said query object, thereby eliminating from further consideration any database records that cannot match said query object at least as closely as defined by a user; and
(v) directly comparing any database records not yet eliminated from consideration with said query object to identify any database records that match said query object at least as closely as defined by a user.

25. The system of claim 24, wherein a number of key objects is greater than three, and each triangle trie includes no less than three levels.

26. The system of claim 24, wherein the machine instructions cause the processor to enable a user to formulate a query based on a combination of distance measures.

27. The system of claim 26, wherein said combination of distance measures comprise at least one of:
(a) a summation function applied to at least two different distance measures, such that data objects not eliminated from further consideration by pruning each triangle trie corresponding to the at least two different distance measures to which the summation function is applied are summed together to generate a summation subset of data objects that potentially match said query object at least as closely as defined by a user;
(b) a maximum function applied to at least two different distance measures, such that data objects not eliminated from further consideration by pruning each triangle trie corresponding to the at least two different distance measures to which the maximum function is applied are merged together by taking an intersection of the data objects not eliminated from further consideration by pruning each triangle trie corresponding to the at least two different distance measures to which the maximum function is applied, said intersection thus producing an intersection subset of data objects that potentially match said query object at least as closely as defined by a user; and
(c) a minimum function applied to at least two different distance measures, such that data objects not eliminated from further consideration by pruning each triangle trie corresponding to the at least two different distance measures to which the minimum function is applied are merged together by taking a union of the data objects not eliminated from further consideration by pruning each triangle trie corresponding to the at least two different distance measures to which the minimum function is applied, said union thus representing a union subset of data objects that potentially match said query object at least as closely as defined by a user.

28. A method for reducing a number of direct comparisons required to identify any data object in a set of data objects that matches a query data object to within at least a specified degree of closeness, said method comprising the steps of:
(a) providing a set of data objects comprising a subset of key objects, a plurality of relational vectors such that for each data object, a relational vector describes at least one type of distance measure between that data object and each key object, at least one triangle trie for each different type of distance measure provided, each triangle trie having a number of levels that is less than a number of key objects in said set of key objects;
(b) enabling a user to select a query object, at least one type of distance measure that will be used to match a data object to said query object, and a degree of closeness used to match a data object to said query object;
(c) determining at least one query relational vector, such that a different query relational vector describes a distance measure between said query object and each key object for each type of distance measure selected;
(d) pruning each triangle trie that is related to a distance measure selected by a user, to eliminate from further consideration any data objects from said set of data objects that cannot match said query object within at least the degree of closeness selected by the user, thereby reducing a number of data objects that potentially will require direct comparisons with said query object;
(e) for each data object not yet eliminated, applying a triangle inequality technique to further reduce the number of data objects that potentially will require direct comparison with said query object; and
(f) directly comparing said query object to any data object remaining for direct comparison following the preceding two steps.

29. A method for reducing a number of direct comparisons required to identify any data object in a set of data objects that matches a query data object within at least a specified degree of closeness, said method comprising the steps of:
(a) pruning at least one triangle trie relating to said set of data objects to eliminate from further consideration any data objects from said set of data objects that cannot match said query object to within at least the specified degree of closeness, thereby reducing a number of data objects that potentially will require direct comparisons with said query object;
(b) for each data object not yet eliminated, applying a triangle inequality technique to further reduce the number of data objects that potentially will require direct comparison with said query object; and
(c) directly comparing said query object to any data object not eliminated in the preceding two steps to identify any data object that matches said query data object within at least said specified degree of closeness.
